(19) United States
(12) Patent Application Publication
(10) Pub. No.: US 2003/0210774 A1
(43) Pub. Date: Nov. 13, 2003

(54) System and method for simultaneous communication and apparatus activation and control

(76) Inventor: Ronald E. Wanderlich, Hampton, NH (US)

Correspondence Address: THOMAS P O'CONNELL, 135 CAMBRIDGE STREET SUITE 10, BURLINGTON, MA, 01803

(21) Appl. No.: 10/141,034

(22) Filed: May 8, 2002

(51) Int. Cl. H04M 11/00

(52) U.S. Cl. 379/102.01

(57) ABSTRACT

A system and method for enabling simultaneous communication and affectation of an operational status of a device for use with a sending device that has a line of communication with a receiving device comprising a receiving/transmitting arrangement operably associated with the line of communication between the sending device and the receiving device for receiving sound signals from the sending device while allowing the receiving device simultaneously to receive the sound signals from the sending device, an activated/controlled device, a line of communication between the receiving/transmitting device and the activated/controlled device, and a transducer for transducing sound signals from the sending device to activate and/or control the activated/controlled device.

### FIELD OF THE INVENTION

The present invention relates generally to sound-operated or actuated devices and systems. Stated more particularly, this patent discloses and protects a system and method for enabling simultaneous communication and affectation of an operational status of a device relative to, for example, a system for providing sensory stimulation to a user that can be induced into operation and controlled by sound.

### BACKGROUND OF THE INVENTION

In his own U.S. Pat. No. 6,028,631 for Terminal Units for a Mobile Communications System, the present inventor disclosed a plurality of embodiments of an invention for enabling unique forms of interpersonal communications. In one embodiment, for example, a terminal unit of a mobile communications system most basically comprises a personal vibrator that can be induced into operation and controlled by one or a series of pager signals input by a potentially remote operator. As such, the invention of the '631 patent certainly provides a number of advantages relative to the relatively mundane arrangements of the prior art.

Over time, however, it has become apparent to the present inventor that there remains room for improvement and modification over his own invention. For example, the inventor has come to appreciate that it would be an advantageous improvement over the invention of the '631 patent to enable a simultaneous operation of a recipient device in conjunction with a communication between a sending person(s) and a receiving person(s). It has also become apparent that there are certain technical difficulties encountered in making widespread application of certain embodiments of the '631 invention.

### SUMMARY OF THE INVENTION

Advantageously, the present invention has as its primary object the provision of a communication and device activation and operation system that meets each of the needs that the prior art has left unmet while providing a number of further advantages thereover.

More particularly, an object of the present invention is to provide a method and system that can enable a simultaneous affectation of the operational status of one or more devices in conjunction with an oral or other sound communication between one or more senders and one or more recipients.

These and further objects and advantages of the invention would be obvious not only to one who reviews the present specification and drawings but also to a person or persons who have the opportunity to take advantage of an embodiment of the present invention for a sound operated communication system.

In carrying forth these objects, one embodiment of the present invention comprises a communication system for enabling a simultaneous affectation of the operational status of one or more devices in conjunction with an oral or other sound communication for use with a sending device that has a line of communication with a receiving device. The communication system includes a receiving/transmitting arrangement operably associated with the line of communication between the sending device and the receiving device for receiving sound signals from the sending device while allowing the receiving device simultaneously to receive the sound signals from the sending device, an activated/controlled device, a line of communication between the receiving/transmitting device and the activated/controlled device, and a transducer for transducing sound signals from the sending device to activate and/or control the activated/controlled device whereby a sender and a recipient can communicate with sounds sent from the sending device to the receiving device while the sounds sent from the sending device can be employed to activate and/or control the activated/controlled device.

By way of example, the receiving device can be a telephone receiving device, such as a wireless telephone or a traditional telephone, with a speaker element for emitting words and other sounds transmitted from the sending device. With this, the line of communication between the receiving/transmitting device and the activated/controlled device can, for example, be a hard wire line of communication or a wireless line of communication. The preferred receiving/transmitting arrangement will include a receiving element for being disposed in aural communication with the speaker element of the receiving device. The receiving element can be retained overlying the speaker element by, for example, a cradle arrangement that overlies a receiving end of the telephone receiving device.

In certain embodiments, the means for transducing sound can simply send an operational signal in response to a receipt of any sound signal from the sending device, but it may be preferable for the operational signals to be dependent on the sound signals received from the sending device. Even more preferably, the means for transducing sound signals from the sending device can employ word recognition such that particular words can be employed to induce particular responses by the activated/controlled device. Still further, the means for transducing sound signals from the sending device can employ voice recognition such that a particular sender or receiver's voice can be employed to induce particular responses by the activated/controlled device. Even more advantageously, where voice and word recognition are employed simultaneously, particular words from a particular sender or receiver can be used to induce particular responses by the activated/controlled device.

The activated/controlled device preferably will incorporate a means for providing tactile sensation to a recipient. By way of example and not limitation, the activated/controlled device could take the form of a personal vibrator that could be phallus shaped possibly with one or more moving or stationary protrusions, a device comprising a body portion with an aperture for providing tactile sensation to a body part of a recipient, or a device with a body portion simulative of all or part of a human body. The tactile sensation could take many forms including vibration, peristaltic action, or any other movement.

It should be understood that the foregoing discussion broadly outlines the more important features of the invention to enable a better understanding of the detailed description that follows and to instill a better appreciation of the inventor's contribution to the art. Before an embodiment of the invention is explained in detail, it must be made clear that the following details of construction, descriptions of geometry, and illustrations of inventive concepts are mere examples of the many possible manifestations of the invention.

### BRIEF DESCRIPTION OF THE DRAWINGS

In the accompanying drawing figures:

FIG. 1 is a schematic view of a communication system according to the present invention;

FIG. 2 is a partially sectioned view in front elevation of a receiving/transmitting arrangement according to the present invention shown coupled to a telephone receiver;

FIG. 3A is a schematic view of an alternative embodiment of the present invention for a communication system;

FIG. 3B is a schematic view of another alternative embodiment of the present invention for a communication system;

FIG. 4 is a view in front elevation of a receiving/transmitting arrangement and an activated/controlled device according to the present invention;

FIG. 5 is a view in front elevation of another receiving/transmitting arrangement and activated/controlled device according to the present invention;

FIG. 6 is a view in front elevation of still another exemplary receiving/transmitting arrangement and an activated/controlled device according to the present invention; and

FIG. 7 is a schematic view of still another embodiment of the present invention for a communication system.

### DETAILED DESCRIPTION

As is the case with many inventions, the present invention for a system and method for enabling simultaneous communication and affectation of an operational status of a device is subject to a wide variety of embodiments. However, to ensure that one skilled in the art will be able to understand and, in appropriate cases, practice the present invention, certain preferred embodiments of the broader invention revealed herein are described below and shown in the accompanying drawing figures.

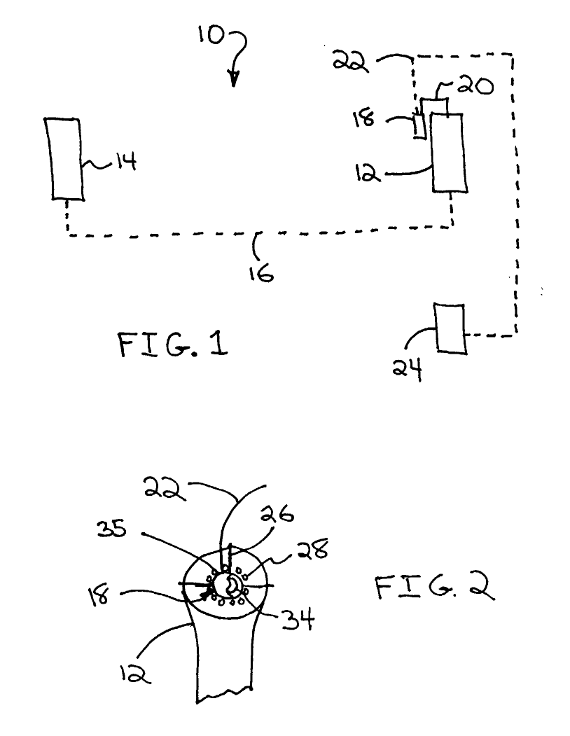

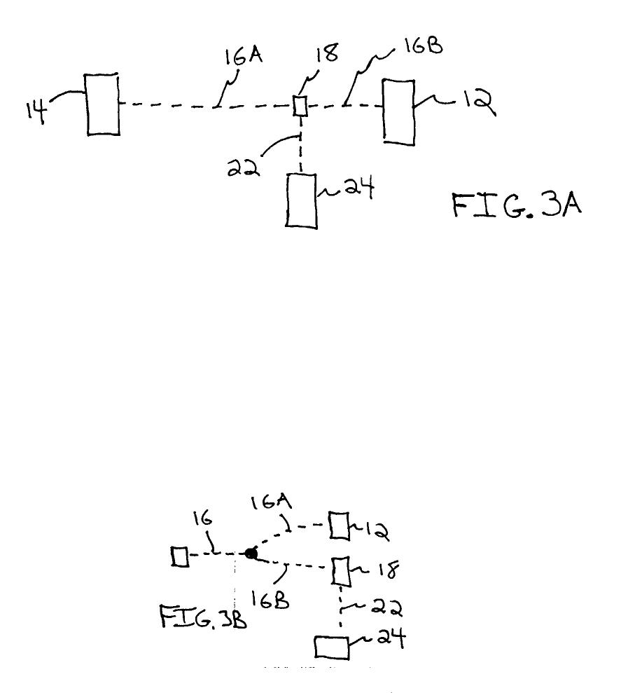

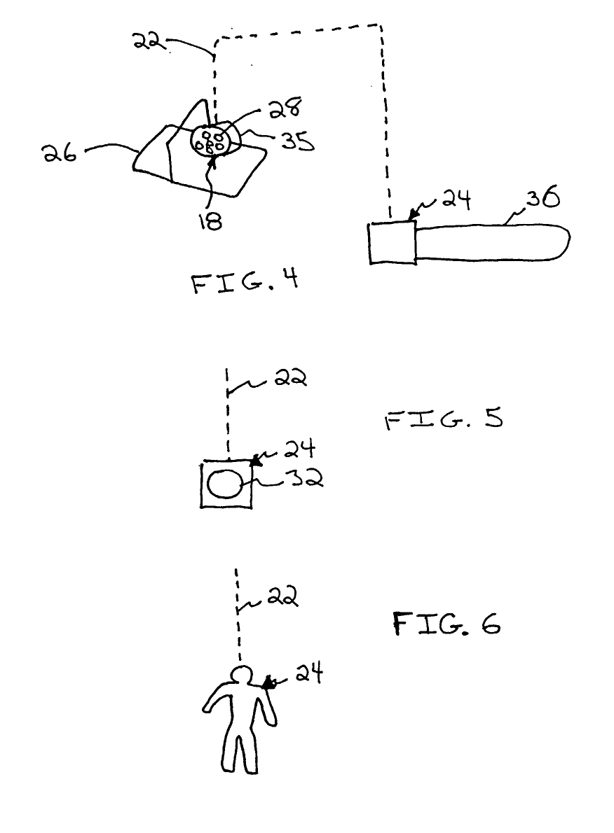

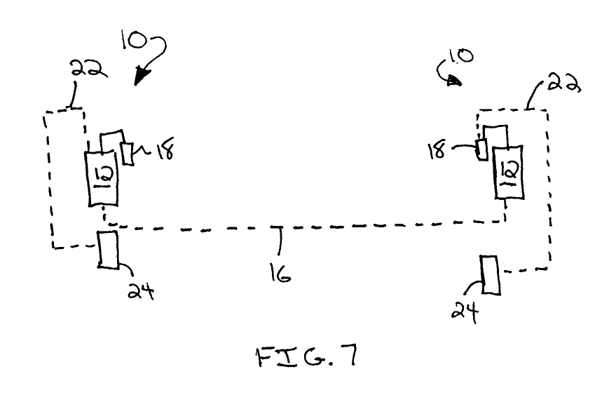

Looking more particularly to the drawings, a preferred embodiment of the present invention in the form of a system for enabling simultaneous communication and affectation of an operational status of a device is indicated generally at 10 in FIG. 1. There, one sees that the system 10 includes a receiving device 12 in communication with a sending device 14 by a line of communication 16. A receiving/transmitting arrangement 18 is, in this embodiment, coupled to the receiving device 12 for perceiving signals, such as tones, words, or other signals, that are sent by the sending device 14 and received by the receiving device 12. The receiving/transmitting arrangement 18 is, in turn, in communication with an activated/controlled device 24 by a line of communication 22.

The sending device 14 could take many forms under the present invention. For example, the sending device 14 could be a conventional telephone, a wireless telephone, a computer, a paging unit, and any other device capable of transmitting a signal. Likewise, the receiving device 12 could be any device capable of receiving a signal including, by way of example and not limitation, a conventional telephone, a wireless telephone, a computer, a paging unit, or any other suitable device. With this, it will be clear that the line of communication 16 could be a landline, a wireless connection, or any other means for enabling a communication between the sending device 14 and the receiving device 12.

The receiving/transmitting arrangement 18 likewise is subject to a variety of embodiments within the scope of the present invention. In the exemplary embodiment of FIG. 2, the receiving device 12 comprises a telephone receiver, which is also indicated at 12. As noted previously, the telephone receiver 12 could be a conventional telephone that employs a landline for communicating with a sending device 14 or a wireless telephone that employs a wireless network for communicating with a sending device 14. In any event, the telephone receiver 12 has a speaker element 28 for emitting words and other sounds transmitted from the sending device 14. The receiving/transmitting arrangement 18 has a receiving element 34 incorporated into a housing 35 for receiving the emitted words or other sounds from the speaker element 28. The housing 35, and thus the receiving element 34, are mechanically coupled to the receiving device 12 by a cradle arrangement 26 that can overly the receiving end of the telephone receiver 12.

The line of communication 22 between the receiving/transmitting arrangement 18 is operable to employ the emitted words or other sounds to induce into operation and/or to control the activated/controlled device 24. To do so, the receiving/transmitting arrangement 18 employs a means for transducing the emitted words or other sounds received from the receiving device 12 to activate or control the activated/controlled device 24 by use of the line of communication 22 therebetween. The line of communication 22 could be a hard wire connection, an infrared line of communication, or any other appropriate means for enabling communication between the activated/controlled device 24 and the receiving/transmitting arrangement 18.

The means for transducing the emitted words or other sounds could simply cause an operational signal to be sent to the activated/controlled device 24 in response to the receipt of any sound by the receiving/transmitting arrangement 18 from the receiving device 12. More preferably, however, the means for transducing the emitted words or other sounds will be capable of differentiating between certain words, sounds, tones, or voices to provide signals to the activated/controlled device 24 that are dependent on the words, voices, tones or other sounds emitted by the receiving device 12.

Even more preferably, the means for transducing the emitted words, voices, or other sounds will be capable of word recognition such that, by means that will be obvious to one skilled in the art after reviewing the present disclosure, particular words can be employed to induce particular responses by the activated/controlled device 24. Also, the means for transducing sound signals from the receiving/transmitting arrangement 18 will be able to employ voice recognition such that a particular sender or receiver's voice can be employed to induce particular responses by the activated/controlled device 24. Even more advantageously, voice and word recognition can be employed simultaneously whereby particular words from a particular sender or receiver can be used to induce particular responses by the activated/controlled device 24.

The activated/controlled device 24 could take numerous forms under the present invention. In certain preferred embodiments, the activated/controlled device 24 will be designed for providing tactile sensations to a recipient. As such, the response of the activated/controlled device 24 to the signal from the receiving/transmitting arrangement 18 can be a vibration, a peristaltic action, or any other movement capable of providing a tactile sensation to the recipient. Even more advantageously, the receiving/transmitting arrangement 18 can employ the means for transducing to effect a control of the duration, severity, or other characteristic of the tactile sensation provided to the recipient.

One preferred embodiment of the activated/controlled device 24 is shown in FIG. 4. There the activated/controlled device 24 takes the form of a personal stimulator, such as a phallus-shaped vibrator possibly with one or more stationary or movable projections, with an elongate member 36 incorporating a vibration or other tactile arrangement for being applied to the body of a recipient. In another embodiment as is shown in FIG. 5, the activated/controlled device 24 could have a body portion with an aperture 32 with a vibratory, peristaltic, and/or other stimulating mechanism for matingly engaging a recipient. Even further, as is shown in FIG. 6, the activated/controlled device 24 could be simulative of all or part of a human body 24 again incorporating a vibratory, peristaltic, or other mechanism for providing a tactile sensation to a recipient.

With such preferred arrangements provided, the present invention can achieve numerous advances beyond the prior art. Taking the embodiment of FIG. 4 as an example, a sender in a given location can, for example, initiate a telephone call to a telephone receiving device 12 with a telephone sending device 14. The sender can then, of course, speak to and otherwise communicate with the recipient. Most advantageously, however, with the receiving element 34 of the receiving/transmitting arrangement 18 overlying the telephone receiver 14, the words and other sounds can simultaneously be heard by the recipient and employed to activate and/or control the activated/controlled device 24 in a manner that enables a most unique form of communication. The sender and the recipient can converse normally while the words they use can manipulate the function of the activated/controlled device 24.

It is possible that mere tones or the general presence or level of sound can activate and/or control the activated/controlled device 24. However, where voice or word recognition is employed, the system 10 can be designed or programmed by the user to have particular person's voices or words induce particular functions in the activated/controlled device 24. The type of conversation and the activation and control words can, of course, be of any character possible. However, in embodiments similar to those of FIGS. 4 through 6, one might expect that the sender and the recipient would have an adult-oriented conversation.

As such, the activation and control words can be pre-programmed or input by the user as words that might commonly be used in an adult-oriented telephone conversation. For example, the voice of one or more persons and/or words like “harder,” “faster,” “softer,” “slower,” and the like can be recognized by the system 10 to manipulate the function of the activated/controlled device 24 while seamlessly furthering the essential goals of the conversation between the sender and the recipient. The activation and control words or voices can, for example, be employed to increase, decrease, or otherwise affect the amplitude, duration, or other characteristic of the tactile sensation provided by the activated/controlled device 24.

It should again be noted that the arrangement of the system depicted in FIG. 1 in which the receiving/transmitting arrangement 18 directly overlies the receiving device 12 such that it would likely be sandwiched between the receiving device 12 and the recipient's ear is merely exemplary. Other arrangements are well within the scope of the invention. For example, it should be clear that the receiving/transmitting arrangement 18 can be associated in any appropriate manner with the sending device 14 and the receiving device 12 to receive and employ the words, voices, tones, and other sounds that are transmitted by either the sending device 14 or the receiving device 12 to activate and control the activated/controlled device 24.

For example, in FIG. 3A, the receiving/transmitting arrangement 18 is disposed in series with the receiving device 12 to bifurcate the line of communication into a first line of communication 16A and a second line of communication 16B. In FIG. 3B, the receiving/transmitting arrangement 18 is disposed in parallel with the receiving device 12 such that the line of communication 16 divides into first and second lines of communication 16A and 16B.

It should also be noted that systems 10 according to the present invention could be employed at both ends of a communication system such that each terminal unit would simultaneously act as a sending device 14 and as a receiving device 12. Such an arrangement is depicted in FIG. 7. Under such an arrangement, each participant can be both a sender and a recipient.

With a plurality of preferred embodiments of the invention disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein.

Accordingly, it will be clear that those with major features of the invention in mind could craft embodiments that incorporate those major features while not incorporating all of the features included in the preferred embodiments. Therefore, the following claims are intended to define the scope of protection to be afforded the inventors. Those claims shall be deemed to include equivalent constructions insofar as they do not depart from the spirit and scope of the invention.

It must be further noted that a plurality of the following claims may express certain elements as means for performing a specific function, at times without the recital of structure or material. As the law demands, these claims shall be construed to cover not only the corresponding structure and material expressly described in this specification but also equivalents thereof.

I claim as deserving the protection of Letters Patent:

1. A sound-operated communication system for use with a sending device that has a line of communication with a receiving device comprising:
a receiving/transmitting arrangement operably associated with the line of communication between the sending device and the receiving device for receiving sound signals from the sending device while allowing the receiving device simultaneously to receive the sound signals from the sending device;
an activated/controlled device;
a line of communication between the receiving/transmitting device and the activated/controlled device; and
a means for transducing sound signals from the sending device to activate and/or control the activated/controlled device;
whereby a sender and a recipient can communicate with sounds sent from the sending device to the receiving device while the sounds sent from the sending device can be employed to activate and/or control the activated/controlled device.

2. The communication system of claim 1 further comprising a receiving device.

3. The communication system of claim 2 wherein the receiving device comprises a telephone receiving device with a speaker element for emitting words and other sounds transmitted from the sending device.

4. The communication system of claim 3 wherein the telephone receiving device comprises a wireless telephone and wherein the line of communication between the sending device and the receiving device comprises a wireless network.

5. The communication system of claim 3 wherein the telephone receiving device comprises a traditional telephone and wherein the line of communication between the sending device and the receiving device comprises a landline.

6. The communication system of claim 1 wherein the line of communication between the receiving/transmitting device and the activated/controlled device comprises a hard wire line of communication.

7. The communication system of claim 1 wherein the line of communication between the receiving/transmitting device and the activated/controlled device comprises a wireless line of communication.

8. The communication system of claim 3 wherein the receiving/transmitting arrangement comprises a receiving element for being disposed in aural communication with the speaker element of the receiving device.

9. The communication system of claim 8 wherein the receiving element of the receiving/transmitting arrangement overlies the speaker element of the telephone receiving device.

10. The communication system of claim 9 further comprising a means for retaining the receiving element of the receiving/transmitting arrangement adjacent to the speaker element of the telephone receiving device.

11. The communication system of claim 10 wherein the means for retaining the receiving element of the receiving/transmitting arrangement adjacent to the speaker element of the telephone receiving device comprises a cradle arrangement for overlying a receiving end of the telephone receiving device.

12. The communication system of claim 1 wherein the means for transducing sound signals from the sending device to activate and/or control the activated/controlled device comprises a means for sending an operational signal to the activated/controlled device in response to a receipt of a sound signal from the sending device.

13. The communication system of claim 12 wherein the means for transducing sound signals from the sending device to activate and/or control the activated/controlled device comprises a means for sending operational signals to the activated/controlled device that are dependent on the sound signals received from the sending device.

14. The communication system of claim 13 wherein the means for transducing sound signals from the sending device to activate and/or control the activated/controlled device comprises a means for word recognition whereby particular words can be employed to induce particular responses by the activated/controlled device.

15. The communication system of claim 13 wherein the means for transducing sound signals from the sending device to activate and/or control the activated/controlled device comprises a means for voice recognition whereby a voice of a particular person or person's can be employed to induce particular responses by the activated/controlled device.

16. The communication system of claim 15 wherein the means for transducing sound signals from the sending device to activate and/or control the activated/controlled device further comprises a means for word recognition whereby particular words can be employed to induce particular responses by the activated/controlled device.

17. The communication system of claim 1 wherein the activated/controlled device comprises a means for providing tactile sensation to a recipient.

18. The communication system of claim 17 wherein the activated/controlled device comprises a personal vibrator.

19. The communication system of claim 17 wherein the activated/controlled device comprises a body portion with an aperture for providing tactile sensation to a body part of a recipient.

20. The communication system of claim 17 wherein the activated/controlled device comprises a body portion simulative of all or part of a human body.

21. The communication system of claim 17 wherein the means for transducing sound signals from the sending device to activate and/or control the activated/controlled device comprises a means for sending an operational signal to the activated/controlled device in response to a receipt of a sound signal from the sending device.

22. The communication system of claim 21 wherein the means for transducing sound signals from the sending device to activate and/or control the activated/controlled device comprises a means for sending operational signals to the activated/controlled device that are dependent on the sound signals received from the sending device.

23. The communication system of claim 22 wherein the means for transducing sound signals from the sending device to activate and/or control the activated/controlled device comprises a means for word recognition whereby particular words can be employed to induce particular responses by the activated/controlled device.

24. The communication system of claim 22 wherein the means for transducing sound signals from the sending device to activate and/or control the activated/controlled device comprises a means for voice recognition whereby a voice of a particular person or person's can be employed to induce particular responses by the activated/controlled device.

25. The communication system of claim 24 wherein the means for transducing sound signals from the sending device to activate and/or control the activated/controlled device further comprises a means for word recognition whereby particular words can be employed to induce particular responses by the activated/controlled device.

26. The communication system of claim I wherein the receiving/transmitting arrangement is disposed in series with the receiving device along the line of communication between the receiving device and the sending device.

27. The communication system of claim 1 wherein the receiving/transmitting arrangement is disposed in parallel with the receiving device to receive signals sent along the line of communication between the receiving device and the sending device.
